(19) United States
(12) Patent Application Publication
(10) Pub. No.: US 2025/0338261 A1
(43) Pub. Date: Oct. 30, 2025

(54) UHR INITIAL CONTROL FRAMES AND INITIAL CONTROL RESPONSES

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Ken Kinwah Ho, San Jose, CA (US); Hongyuan Zhang, Fremont, CA (US)

(21) Appl. No.: 19/189,169

(22) Filed: Apr. 24, 2025

Related U.S. Application Data
(60) Provisional application No. 63/638,856, filed on Apr. 25, 2024.
(60) Provisional application No. 63/652,370, filed on May 28, 2024.

(51) Int. Cl. H04W 72/0446; H04L 5/00; H04W 28/02

(52) U.S. Cl. CPC H04W 72/0446; H04L 5/0055; H04W 28/0278

(57) ABSTRACT

Methods and apparatus are described for communicating initial control information between devices of a wireless network. In a method, a first wireless device generates an Initial Control Frame (ICF) or an Initial Control Response (ICR) including initial control information. The initial control information includes common initial control information for one or more recipient wireless devices and per-STA initial control information for a specific recipient wireless device of the one or more recipient wireless devices. The first wireless device subsequently transmits the ICF or ICR for receipt by the one or more recipient wireless devices. In various embodiments, the ICF or ICR is a protected/unprotected Trigger frame (e.g., a Buffer Status Report Poll (BSRP) Trigger frame), and the common initial control information and per-STA initial control information are included in a padding field of the Trigger frame.

### CROSS REFERENCE TO RELATED APPLICATIONS

The present U.S. Utility Patent Application claims priority pursuant to 35 U.S.C. § 119(e) to U.S. Provisional Application No. 63/638,856, entitled “CONTROL FRAME DESIGN”, filed Apr. 25, 2024, and U.S. Provisional Application No. 63/652,370, entitled “ICF/ICR CONSIDERATION”, filed May 28, 2024, the contents of both of which are hereby incorporated herein by reference in their entirety and made part of the present U.S. Utility Patent Application for all purposes.

### BACKGROUND

### Technical Field

This disclosure relates generally to wireless communications, and more specifically to the exchange of initial control information between wireless devices of a network.

### Description of Related Art

Wireless local area networks (WLANs) have evolved rapidly over the past couple of decades, including WLANs that conform to the Institute of Electrical and Electronics Engineers (IEEE) 802.11 family of standards. A typical 802.11-based WLAN is formed by one or more access points (APs) that provide a shared wireless communication medium for servicing a number of client devices or stations (STAs). In particular, an AP manages a Basic Service Set (BSS) that is identified by a Basic Service Set Identifier (BSSID) and advertised by the AP. The AP periodically broadcasts beacon frames to enable STAs within wireless range of the AP to establish and maintain communication links with the AP.

In such WLANs, an AP or a STA (e.g., a non-AP STA) transmits data within a transmit opportunity (TXOP) after it has gained contention for a wireless medium. In general, a TXOP is a designated time duration for which the AP/STA can transmit frames after contention. Typically, an AP grants the AP/STA high priority access (as compared to other devices of a BSS) to the wireless medium (or channel) for a set duration. Control information can be used in a WLAN to manage and optimize such wireless communications. Various control fields have been introduced in the IEEE 802.11 standard to carry control information in certain legacy frames. Such fields include the QoS Control field (for QoS Data/Null frames) and the HT Control field introduced in 802.11n/Wi-Fi 4 (for QoS Data/Null frames and Management frames). The 802.11ax/Wi-Fi 6 amendment to the 802.11 standard further defined an A-Control field to carry control information relating to, for example, timing and resource allocations for multiple stations. Each of these control fields is of relatively limited size.

### BRIEF DESCRIPTION OF THE DRAWINGS

One or more embodiments will now be described by way of example only with reference to the accompanying drawings, in which:

FIG. 1 illustrates an example of a multi-link communications system in accordance with embodiments of the present disclosure;

FIG. 2 depicts an example format of a modified protected Trigger frame including common initial control information in accordance with embodiments of the present disclosure;

FIG. 3 depicts an example format of a modified unprotected Trigger frame including common initial control information in accordance with embodiments of the present disclosure;

FIG. 4 illustrates an example of per user initial control information in an Initial Control Frame (ICF) Trigger frame in accordance with embodiments of the present disclosure;

FIG. 5A illustrates an example of a User Initial Control Info List field of FIG. 4 in accordance with an embodiment of the present disclosure;

FIG. 5B illustrates an example of the Per User Initial Control Info field of

FIG. 5A in accordance with an embodiment of the present disclosure;

FIG. 6 illustrates another example of a modified Trigger frame including initial control information in accordance with an embodiment of the present disclosure;

FIG. 7 illustrates an example of an Initial Control Response (ICR) Multi-STA BlockAck frame including common initial control information in accordance with embodiments of the present disclosure;

FIG. 8 illustrates an example of the Common Initial Control Per AID TID Info field of FIG. 7 in accordance with an embodiment of the present disclosure;

FIG. 9 illustrates an example of an Initial Control Response (ICR) Multi-STA BlockAck frame including per-STA initial control information in accordance with embodiments of the present disclosure;

FIG. 10 illustrates an example of the Per-STA Initial Control Per AID TID Info field of FIG. 9 in accordance with an embodiment of the present disclosure;

FIG. 11 is a flow chart illustrating an example method for communicating initial control information in accordance with an embodiment of the present disclosure;

FIG. 12 is a flow chart illustrating another example method for communicating initial control information in accordance with an embodiment of the present disclosure; and

FIG. 13 illustrates an example of an access point according to an embodiment of the present disclosure.

### DETAILED DESCRIPTION

The various implementations described in the following description relate generally to new or updated frame formats and methodologies for efficiently and securely exchanging initial/dynamic control information between wireless devices of a wireless. More particularly, innovative frame formats (e.g., Control frame formats) are described to support (legacy and non-legacy) networking features such as enhanced power saving features, in-device coexistence features, switching between capability modes, and other features associated with the IEEE 802.11bn amendment (also referred to as Ultra High Reliability or “UHR” or “Wi-Fi 8”) and future (or earlier) generations of the IEEE 802.11 standard.

In an example, a first wireless device generates an Initial Control Frame (ICF) including initial control information. The initial control information includes common initial control information for one or more recipient wireless devices and per-STA initial control information for a specific recipient wireless device of the one or more recipient wireless devices. The first wireless device subsequently transmits the ICF or ICR for receipt by the one or more recipient wireless devices. In various embodiments, the ICF is a protected/unprotected Trigger frame (e.g., a Buffer Status Report Poll (BSRP) Trigger frame), and the common initial control information and per-STA initial control information are included in a (Special) User Info field of the Trigger frame having an AID 12 field value greater than 2007. In various embodiments, the ICR is a protected/unprotected Multi-STA Block Ack frame (also referred to herein as “Multi-STA BA” or “M-BA” frame), and the common initial control information and per-STA initial control information are included in a Per AID TID Info field of the Multi-STA BA frame having an AID 12 field value greater than 2007.

As used herein, the term “non-legacy” may refer to physical layer protocol data unit (PPDU) formats and communication protocols conforming with the IEEE 802.11bn amendment to the IEEE 802.11 standard (“802.11bn”) as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11standard, or earlier generations of the IEEE 802.11 standard, but not conforming to all mandatory features of 802.11bn or future generations of the IEEE 802.11 standard. In some implementations, the frame formats described herein may be configurable to support multiple versions of the IEEE 802.11 standard.

As used herein, dynamic control information generally refers to control data (e.g., channel selection, modulation rates, power saving operations, in-device coexistence mechanisms, etc.) that may change or be adjusted to account for current network conditions and requirements. Initial control information generally refers to static or predefined control data that is exchanged during the setup or configuration of a communication session. Initial control information typically remains fixed for the duration of a session unless it is updated with dynamic control information.

Particular implementations of the subject matter described in the present disclosure can be implemented to realize one or more of the following potential advantages. By improving and expanding control information exchange capabilities (particularly in Control frames), the described frame formats and methods enhance support for networking features such as enhanced power saving features, in-device (radio) coexistence features, per TXOP Tx/Rx parameter negotiation and TXOP allocations, etc. Further, the novel frame formats described herein can be defined for use in existing Control frame types, thereby avoiding the need to define a new Control frame(s). In addition, the frame formats and methods described herein help enable gains in overall network throughput (particularly in high-density environments) that will be achievable in accordance with the IEEE 802.11bn amendment of the IEEE 802.11 standard.

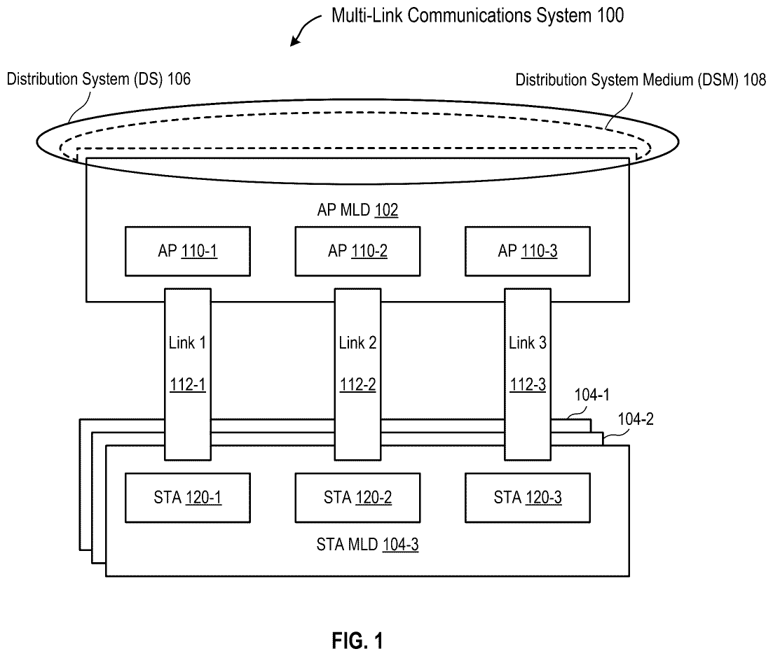

FIG. 1 illustrates an example of a multi-link (ML) communications system 100 in accordance with embodiments of the present disclosure. The illustrated multi-link communications system 100 includes at least one AP multi-link device (MLD) 102 and one or more non-AP multi-link devices (which may also be referred to as a “non-AP MLD” or “STA MLD”), which are, for example, implemented as station (STA) MLDs 104-1, 104-2, and 104-3. The multi-link communications system 100 can be used in various applications, such as industrial applications, medical applications, computer applications, and/or consumer or appliance applications. In the illustrated example, the multi-link communications system is a wireless communications system compatible with an IEEE 802.11 standard. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 shown in FIG. 1 includes the AP MLD 102 and the STA MLDs 104-1, 104-2, and 104-3, in other embodiments, the multi-link communications system includes other multi-link devices, such as, multiple AP MLDs and multiple STA MLDs, a single AP MLD and a single STA MLD. In another example, the multi-link communications system includes more than three STA MLDs and/or less than three STA MLDs. In yet another example, although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, and 110-3. In some embodiments, the AP MLD 102 is an AP multi-link logical device. In some embodiments, a common part of the AP MLD 102 implements upper layer Media Access Control (MAC) functionalities (e.g., association establishment, reordering of frames, etc.) and a link specific part of the AP MLD 102, i.e., the APs 110-1, 110-2, and 110-3, implement lower layer MAC functionalities (e.g., backoff, frame transmission, frame reception, etc.). The APs 110-1, 110-2, and 110-3 may be implemented in hardware (e.g., circuits), software, firmware, or a combination thereof. At least one of the APs 110-1, 110-2, or 110-3 may be fully or partially implemented as an integrated circuit (IC) device. In some embodiments, the AP MLD and its affiliated APs 110-1, 110-2, and 110-3 are compatible with at least one WLAN communications standard (e.g., at least one IEEE 802.11 standard). For example, the APs 110-1, 110-2, and 110-3 may be wireless APs compatible with at least one non-legacy IEEE 802.11 standard.

In some embodiments, an AP MLD (e.g., the AP MLD 102) is connected to a local network (e.g., a local area network (LAN)) and/or to a backbone network (e.g., the Internet) through a wired connection and wirelessly connects to wireless STA MLDs, for example, through one or more WLAN communications standards, such as an IEEE 802.11 standard. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. The at least one controller may be implemented within a processor, such as a microcontroller, a host processor, a host, a digital signal processor (DSP), processing module, or a central processing unit (CPU), which can be integrated in a corresponding transceiver.

Each of the APs 110-1, 110-2, and 110-3 of the AP MLD 104 may operate in the same different frequency bands. For example, at least one of the APs 110-1, 110-2, or 110-3 of the AP MLD 104 operates in an Extremely High Frequency (EHF) band or the “millimeter wave (mmWave)” frequency band. In some embodiments, a mmWave link may operate in a 45 GHz or 60 GHz frequency band. In a specific example, the AP 110-1 may operate in a 6 GHz band (e.g., with a 320 MHz Basic Service Set (BSS) operating channel or other suitable BSS operating channel), the AP 110-2 may operate in a 5 GHz band (e.g., with a 160 MHz BSS operating channel or other suitable BSS operating channel), and the AP 110-3 may operate in a 60 GHz band (e.g., with a 160 MHz BSS operating channel or other suitable BSS operating channel).

In the illustrated embodiment, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 (non-AP MLD) includes radios, which are implemented as multiple non-AP stations (STAs) 120-1, 120-2, and 120-3. The STAs 120-1, 120-2, and 120-3 may be implemented in hardware (e.g., circuits), software, firmware, or a combination thereof. At least one of the STAs 120-1, 120-2, and 120-3 may be fully or partially implemented as an IC device. In some embodiments, the non-AP STAs 120-1, 120-2, and 120-3 are part of the STA MLD 104-1, such that the STA MLD may be a communications device that wirelessly connects to an AP MLD, such as, the AP MLD 102. For example, the STA MLD 104-1 (e.g., at least one of the non-AP STAs 120-1, 120-2 or 120-3) may be implemented in a laptop, a desktop computer, a mobile phone, or other communications device that supports at least one W LAN communications standard. In some embodiments, the STA MLD and its affiliated STAs 120-1, 120-2, and 120-3 are compatible with at least one IEEE 802.11 standard. In an example, each of the non-AP STAs 120-1, 120-2, and 120-3 includes at least one antenna, at least one transceiver operably connected to the at least one antenna, and at least one controller connected to the corresponding transceiver. The at least one transceiver may include a PHY device. The at least one controller can be configured to control the at least one transceiver to process received packets through the at least one antenna. In some embodiments, the at least one controller is implemented by a processor, such as a microcontroller, a host processor, a host, a DSP, processing module, or a CPU, which can be integrated in a corresponding transceiver. In an example, the STA MLD has one MAC data service interface. In another example, a single address is associated with the MAC data service interface and is used to communicate on the DSM 108. In some embodiments, the STA MLD 104-1 implements a common MAC data service interface and the non-AP STAs 120-1, 120-2, and 120-3 implement a lower layer MAC data service interface.

In an example, the AP MLD 102 and/or the STA MLDs 104-1, 104-2, and 104-3 identify which communications links support the multi-link operation during a multi-link operation setup phase and/or exchanges information regarding multi-link capabilities during the multi-link operation setup phase. In addition, each of the STAs 120-1, 120-2, and 120-3 of the STA MLD may operate in the same frequency band or different frequency bands. For example, at least one of the STAs 120-1, 120-2, or 120-3 of the STA MLD 104-1 operates in the mmWave frequency band (e.g., a 45 GHz or 60 GHz frequency band). In an example, the STA 120-1 may operate in a 6 GHz band (e.g., with a 320 MHz BSS operating channel or other suitable BSS operating channel), the STA 120-2 may operate in a 5 GHz band (e.g., with a 160 MHz BSS operating channel or other suitable BSS operating channel), and the STA 120-3 may operate in a 60 GHz band (e.g., with a 640 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the STA MLD 104-1. For example, the MLD 104-2 and 104-3 include one or multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller can be configured to control the at least one transceiver to process received packets through the at least one antenna. In some embodiments, the at least one controller is implemented by a processor, such as a microcontroller, a host processor, a host, a DSP, a processing module, or a CPU, which can be integrated in a corresponding transceiver.

In the illustrated network, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding wireless communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. In some embodiments, the wireless communications links in the multi-link communications system include one or more 2.4 GHz, 5 GHz, 6 GHz, 45 GHz and/or 60 GHz links.

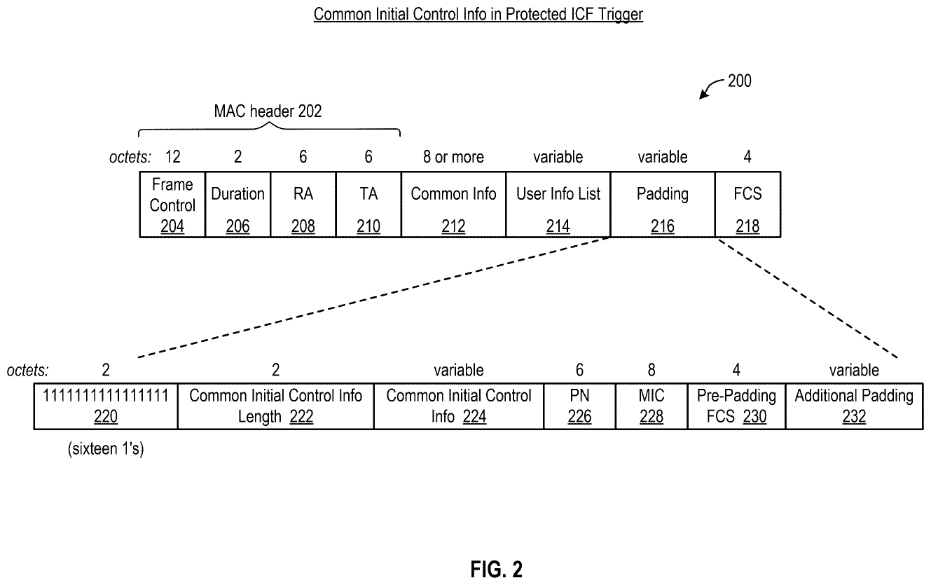

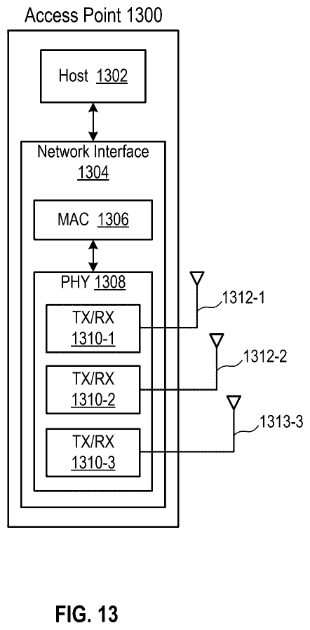

FIG. 2 depicts an example format of a modified protected Trigger frame 200 including common initial control information in accordance with embodiments of the present disclosure. In the illustrated embodiment, the common initial control information is carried in a padding field of the Trigger frame 200. In an example, the Trigger frame 200 is a MAC Control frame included in a PPDU generated by an access point (e.g., the AP MLD 102 or STA MLD 104 described with reference to FIG. 1 or the wireless network device/AP 1300 described with reference to FIG. 13), and is transmitted to one STA/AP or a plurality of client STAs (i.e., recipient wireless devices). In addition to common initial control information, the Trigger frame 200 may include resource unit allocation indications and other transmission parameters to be used for transmission of an uplink OFDMA or UL MU MIMO data unit during a transmit opportunity (TXOP). For example, the Trigger frame 200 may be included in a PPDU that conforms with the IEEE 802.11bn, 802.11be, 802.11ax or other amendment to the IEEE 802.11 standard. In some examples, the Trigger frame 200 can be used by a non-AP STA to solicit a non-TB PPDU(s) carrying various control information in a Control frame. The Trigger frame 200 of this embodiment may include additional fields and capabilities as specified in IEEE 802.11be (e.g., a Special User Information field) and future amendments to the IEEE 802.11 standard, including IEEE 802.11bn.

The illustrated Trigger frame 200 includes a MAC header 202, a Common Information (“Common Info”) field 212, a User Information (“User Info”) List field 214, a padding field 216, and a frame check sequence (FCS) field 218. The MAC header 202 includes a Frame Control field 204, a Duration field 206 (containing information for timing synchronization or identification), a receiver address (RA) field 208, and a transmitter address (TA) field 210. In an example, the Common Info field 212 and User Info List field 214 carry configuration information which may be used by a receiving device to configure a TB PPDU that is transmitted in response to receiving the Trigger frame 200 (unless the Trigger frame solicits a non-TB PPDU). In an example, the User Info List field 214 may include one or more User Information (“User Info”) fields, each of which carries per-User information for a respective user, while the Common Info field 212 may carry information (such as parameters for a TB PPDU transmission) that is common to all recipients (e.g., any users associated with User Info fields of the User Info List field 214) of the Trigger frame 200. The number of octets of bits allocated to each field of the Trigger frame 200, according to this example, is indicated in FIG. 2 above the corresponding field.

In an example, the Frame Control field 204 includes a plurality of subfields including a type subfield indicating that the frame is a Control frame and a subtype subfield indicating a subtype (e.g., a value of 4 for a BSRP trigger type) of the frame. In another example, the (legacy) FCS field 218 is a 32-bit field containing a 32-bit CRC value. The FCS is calculated over all the fields (i.e., “calculation fields”) of the MAC header and the frame body fields. The FCS value may be calculated and appended to a Trigger frame by an AP prior to transmission. Upon receipt of the Trigger frame by a client device, the client device can calculate an FCS value for the frame and compare it with the FCS value calculated by the AP. If the two FCS values match, it is assumed that the frame was not corrupted during transmission. If the two FCS values are different, an error is assumed and the frame is discarded.

The variable length padding field 216 of the illustrated Trigger frame 200 includes a padding indication 220, a Common Initial Control Info Length field 222, a Common Initial Control Information field 224, a Packet Number (PN) field 226, a Message Integrity Check (MIC) field 228, a Pre-Padding FCS field 230 (or “intermediate FCS field”), and additional padding 232. In part, the padding field 216 is present in the Trigger frame 200 to extend the frame length for the following purposes: (1) to give the recipient STAs enough time to prepare a response (e.g., an Initial Control Response (ICR)) for transmission an SIFS after the frame is received and (2) to align the end time of simultaneously transmitted PPDUs.

In the illustrated example, the Common Initial Control Information field 224 carries common initial control information for recipient wireless devices. The Common Initial Control Info Length field 222 operates to indicate the length of the Common Initial Control Information field 224 (e.g., in octets), and follows the first 16 bits (padding indication 220) of the Padding field 216. In this example, the first 16 bits are all set to 1's (e.g., to indicate the beginning of the padding field and/or indicate the presence of fields 222-230). The Pre-Padding FCS field 230, if present, is followed by the additional padding 232.

In an example, the Common Initial Control Information field 224 includes 0 (when no common initial control information exists), 1 or multiple Type+Length+Content tuples carrying common initial control information. In another example, the Trigger frame 200 includes a (defined) Special User Information field (or “Special User Info field”) that provides additional common information for TB PPDU transmissions and an indication of the presence of the Common Initial Control Information field 224. In this example, the Common Initial Control Information Length field 222 may be omitted. In another example, an addressed STA that does not support initial control information but needs to check a Pre-Padding FCS value may determine the location of the PN field 226 and MIC field 228 by decoding the length of each Type+Length+Content tuple of the Common Initial Control Information field 224. An addressed STA that does not support initial control information and control frame protection may determine the location of the Pre-Padding FCS value by decoding the length of each Type+Length+Content tuple of the Common Initial Control Information field 224 and skipping the 14-octect PN+MIC values.

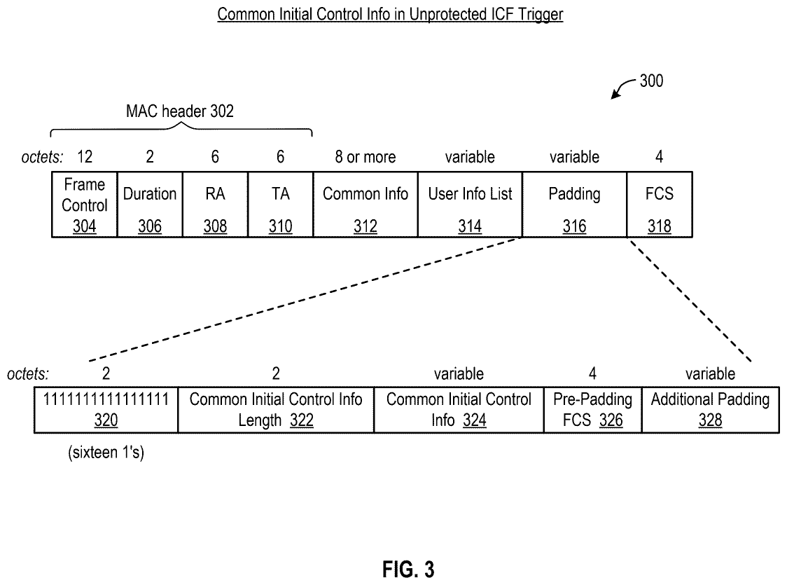

FIG. 3 depicts an example format of a modified unprotected Trigger frame 300 including common initial control information in accordance with embodiments of the present disclosure. In the illustrated example, the unprotected Trigger frame 300 includes a MAC header 302, a Common Information field 312, a User Information List field 314, a padding field 316, and an FCS field 318. The MAC header 302 includes a Frame Control field 304, a Duration field 306, an RA field 308, and a TA field 310. The illustrated padding field 316 includes a padding indication 320, a Common Initial Control Info Length field 322, a Common Initial Control Information field 324, a Pre-Padding FCS field 326, and additional padding 328. In this example, the various fields 304-328 of the Trigger frame 300 generally correspond to the similarly labeled fields of the Trigger frame 200 described with reference to FIG. 2. In this example, however, the PN field 226 and the MIC field 228 of FIG. 2 are omitted or reserved in the Padding field 316 of the unprotected Trigger frame 300.

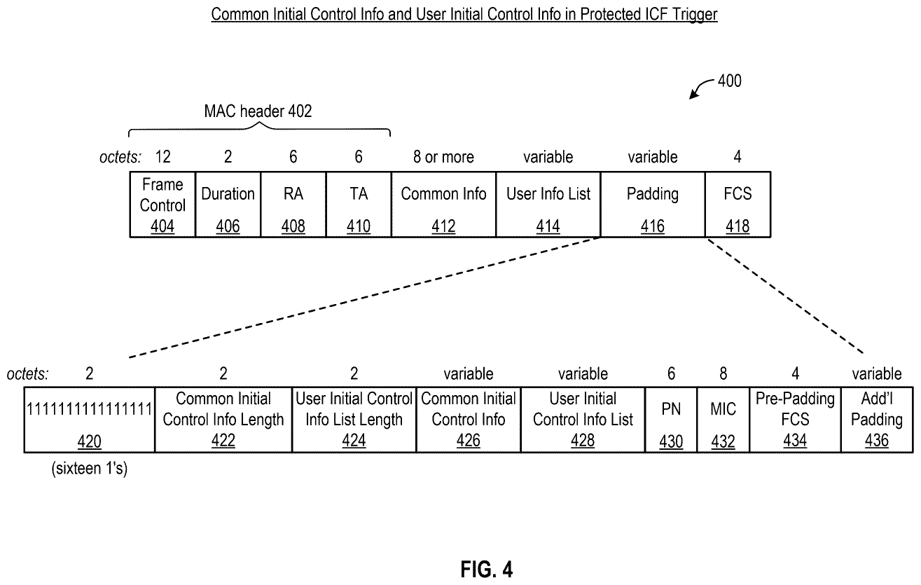

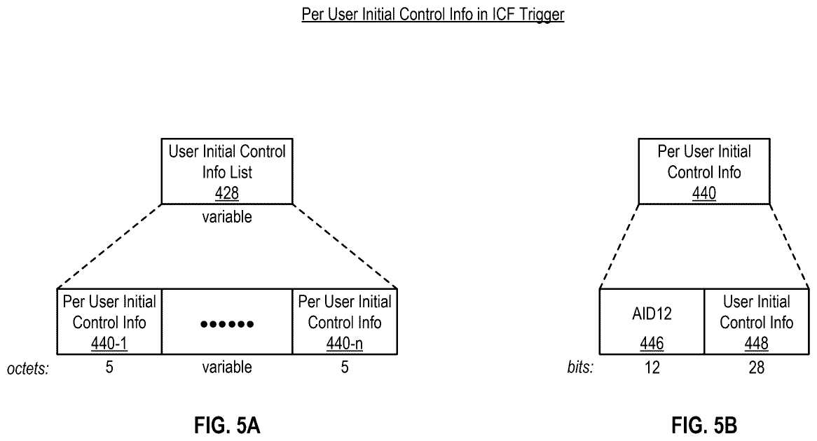

FIG. 4 illustrates an example of per user initial control information in a protected Initial Control Frame (ICF) Trigger frame 400 in accordance with embodiments of the present disclosure. In the illustrated example, the Trigger frame 400 includes a MAC header 402, a Common Information field 412, a User Information List field 414, a padding field 416, and an FCS field 418. The MAC header 402 includes a Frame Control field 404, a Duration field 406, an RA field 408, and a TA field 410. The illustrated padding field 416 includes a padding indication 420, a Common Initial Control Info Length field 422, a User Initial Control Info List Length field 424, a Common Initial Control Information field 426, a User Initial Control Information List field 428 (having a length indicated by the User Initial Control Information List Length field 424), a PN field 430, a MIC field 432, a Pre-Padding FCS field 434, and additional padding 436. In this example, the various fields 404-422, 426, and 430-436 of the Trigger frame 400 generally correspond to the similarly labeled fields of the Trigger frame 200 described with reference to FIG. 2. In this example, the User Initial Control Information List field 428 follows the Common Initial Control Information field 426 and carries per-STA (alternatively referred to herein as “per-User” or “Per User”) initial control information for an addressed recipient wireless device(s) of one or more recipient wireless devices. For example, the User Initial Control Information List field 428 includes 0, 1 or multiple Type+Length+Content tuples carrying per-User initial control information. An example of a format of the User Initial Control Information List field 428 is described in greater detail with reference to FIGS. 5A and 5B.

In another example, the Trigger frame 400 includes a Special User Information field (not separately illustrated) that provides an indication of the presence of the User Initial Control Information List field 428. In this example, User Initial Control Info List Length field 424 may be omitted. In another example, an addressed STA that does not support initial control information but needs to check a Pre-Padding FCS value may determine the location of the PN field 430 and MIC field 432 by decoding the length of each Type+Length+Content tuple of the Common Initial Control Information field 426 and the User Initial Control Information List field 428. An addressed STA that does not support initial control information and control frame protection may determine the location of the Pre-Padding FCS value by decoding the length of each Type+Length+Content tuple of the Common Initial Control Information field 426 and the User Initial Control Information List field 428 and skipping the per-User initial control information fields and the 14-octect PN+MIC values.

FIG. 5A illustrates an example of a User Initial Control Info List field 428 of FIG. 4 in accordance with an embodiment of the present disclosure. In the illustrated embodiment, the User Initial Control Info List field 428 carries initial control information for an addressed wireless device in one or multiple Per User Initial Control Information fields 440-n. In an example, each Per User Initial Control Information field 440 for a STA has the same length as a User Information field addressed to the STA that is used to carrying a resource allocation(s) for a responsive frame from the addressed STA. In another example, each Per User Initial Control Information field 440 has the same length as a Special User Information field as defined in IEEE 802.11be. An example of a format of the Per User Initial Control Information field 440 is described in greater detail with reference to FIG. 5B.

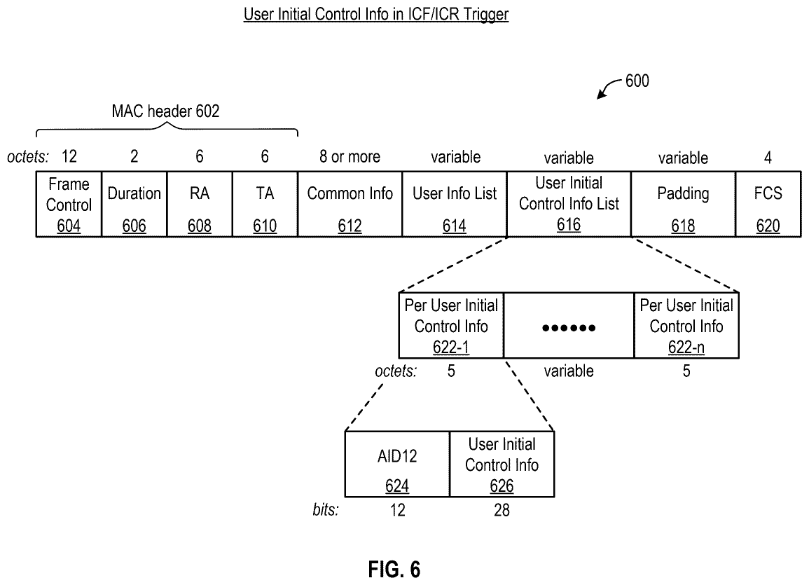

FIG. 5B illustrates an example of the Per User Initial Control Info field 440 of FIG. 5A (and the Per User Initial Control Info field 622 of FIG. 6) in accordance with an embodiment of the present disclosure. The Per User Initial Control Information field 440 of this example includes an AID 12 subfield 446 and a User Initial Control Information subfield 448. The AID 12 subfield 446 includes an AID value that uniquely identifies a specific STA within a group of STAs being addressed (e.g., in a multi-station aggregation scenario) and may have the same coding rules as the AID 12 field in a Per User Information field for the specific STA that is used to allocate a resource(s) for transmission of a responsive frame. In another example, the AID 12 subfield 446 includes an AID value greater than 2007 if the Per User Initial Control Info field 440 for a specific STA immediately follows a User Info field carrying a resource allocation for a responsive frame from the specific STA. In one example, Per-STA initial control information of a specific information type for a STA identified by an AID value is carried, for example, in one Type+Length+Content tuple in one Per User Initial Control Info field if one Per User Initial Control Info field can carry the information, or multiple Type+Length+Content tuples in multiple Per User Initial Control Information fields 440 if one Per User Initial Control Info field is not sufficient to carry the information. In another example, Per-STA initial control information of multiple specific information types for a STA identified by an AID value is carried in Type_Length+Content tuples in one Per User Initial Control Info field if one Per User Initial Control Info field can carry information of multiple types.

FIG. 6 illustrates another example of a modified Trigger frame 600 including initial control information in accordance with an embodiment of the present disclosure. In the illustrated example, the Trigger frame 600 includes a MAC header 602, a Common Information field 612, a User Information List field 614, a User Initial Control Info List field 616, a padding field 618, and an FCS field 620. The MAC header 402 includes a Frame Control field 604, a Duration field 606, an RA field 608, and a TA field 610. In this example, the various fields 604-614, 618, and 620 of the Trigger frame 600 generally correspond to the similarly labeled fields of the Trigger frame 200 described with reference to FIG. 2, and the various fields 616 and 622-626 generally correspond to the similarly labeled fields 428-448 described with reference to FIGS. 5A and 5B. In this example, however, the User Initial Control Info List field 616 precedes the padding field 618 (as opposed to being part of the padding field 618).

In the illustrated embodiment, the User Initial Control Info List field 616 carries initial control information for an addressed wireless device(s) in one or multiple Per User Initial Control Information fields 622-n. In an example, each Per User Initial Control Information field 622 has the same length as a Special User Information field as defined in IEEE 802.11be. An example of a format of the Per User Initial Control Information field 622 is described in greater detail with reference to FIG. 5B.

In an example, each Per User Initial Control Information field 622 for a specific recipient wireless address immediately follows a User Info field allocating a resource(s) to the single recipient wireless device, such as resources for a responsive PPDU transmission (e.g., various fields of the User Info List field 614 and the User Initial Control Info List field 616 may be intermingled). In another example, the User Initial Control Info List field 616 carries one or more types of initial control information (e.g., in a User Initial Control Information subfield 448) for one or more recipient wireless devices. In this example, each type of initial control information for multiple recipient wireless devices is carried in one Per User Initial Control Information field 622, and each type of initial control information for a single recipient wireless device is carried in one Per User Initial Control Information field 622.

In another example, a Per User Initial Control Information field 622 for a single recipient wireless device includes an Association ID (AID 12) subfield 624 having a value that identifies the single recipient wireless device. In a further example, a Per User Initial Control Information field for multiple recipient wireless devices includes an Association ID (AID 12) subfield having a value greater than 2007 and less than 2047. In another example, the Trigger frame 600 includes an explicit indicator (e.g., in a Common Info field 612) that indicates whether a responding frame is to be carried in a TB PPDU or non-TB PPDU.

Various options are described below for exchanging dynamic initial control information utilizing a BSRP Trigger frame as an Initial Control Frame (ICF). In a first example, the BSRP Trigger frame includes a currently reserved bit(s) (e.g., of a Common Information field or Special User information field) that is defined as a “Dynamic Initial Control Information Soliciting field” to explicitly indicate whether dynamic initial control information (e.g., unavailable start time(s) and unavailable duration(s)) and/or a resource request (e.g., a buffer status report) is solicited from the second wireless device. A resource request may include, for example, an explicit request for access to network resources, such as bandwidth or transmission opportunities (e.g., for peer-to-peer frame exchanges within a TXOP). In one variant of this example, if the Dynamic Initial Control information Soliciting field is a bit set to 1, the dynamic initial control information is solicited from a second wireless device that supports reporting such information. Otherwise, a resource request is not solicited from the second wireless device. In yet another variant, a currently reserved bit in a Common Information field or Special User Information field (“Dynamic Initial Control Information Soliciting field”) is defined to indicate whether the BRSP Trigger frame solicits dynamic initial control information, and another reserved bit in a Common Information field or Special User Information field (“Resource Request Soliciting field”) is defined to indicate whether BRSP Trigger frame solicits a resource request. In an example, both dynamic initial control information and a resource request are solicited from the second wireless device (e.g., both fields are set to 1). In another example, only one of dynamic initial control information or a resource request are solicited. For a STA that does not support the reporting of dynamic initial control information, a resource request can be solicited from an addressed STA (e.g., a STA that supports the reporting of dynamic initial control information).

In another example, the BRSP Trigger frame is redefined such that either a resource request or dynamic initial control information is implicitly solicited (by default) as feedback from a recipient wireless device. In this example, a currently reserved bit of the BSRP Trigger frame (e.g., of a Common Information field or Special User Information field) is defined to explicitly solicit dynamic initial control information when a resource request is the default feedback, or to explicitly solicit a resource request when dynamic initial control information is the default feedback. In yet another example, a BSRP Trigger frame is redefined to implicitly solicit both dynamic initial control information and a resource request from a recipient wireless device. In either of these examples, for a STA that does not support the reporting of dynamic initial control information, a resource request can be solicited from an addressed STA (e.g., a STA that supports the reporting of dynamic initial control information).

In a further example, for a STA that does not support the reporting of dynamic initial control information, a resource is implicitly solicited from an addressed STA that supports the reporting of dynamic initial control information. For a STA that supports the reporting of dynamic initial control information, if a BSRP Trigger frame is the first BSRP Trigger frame addressed to a STA in a TXOP, the BSRP Trigger frame implicitly solicits dynamic initial control information from a recipient wireless device. In a variant, if a BSRP Trigger frame is the first BSRP Trigger frame addressed to a STA in a TXOP, both dynamic initial control information and a resource request are solicited from a recipient wireless device. Continuing with this example, if a BSRP Trigger frame is not the first BSRP Trigger frame addressed to a STA in a TXOP, the BSRP Trigger frame solicits a resource request from the STA.

With respect to a wireless device(s) that receives a BSRP Trigger frame such as described above, a response/ICR may take various forms depending, in part, on the type of information that is solicited. In an example, a recipient wireless device can generate and transmit an A-MPDU that includes a Multi-STA BA carrying dynamic initial control information and a QoS Null frame providing a buffer status report if a TB PPDU carries the response, otherwise, the Multi-STA BA carrying dynamic initial control information is in a responsive non-TB PPDU. In another example, a response includes a single Multi-Sta BA carrying dynamic initial control information and/or a single QoS Null frame carrying a buffer status report in an A-MPDU. In further examples, a response includes a single Multi-Sta BA carrying dynamic initial control information and a buffer status report, a single Multi-Sta BA carrying dynamic initial control information, and/or a single QoS Null frame carrying a buffer status report.

In an example, the various types of dynamic initial control information can be organized through Type+Length+Content tuples. In another example, a resource request is similarly carried in one Type+Length+Content tuple. In further examples, the various types of dynamic initial control information can be organized through Type+Content tuples, and a resource request can be organized through a Type+Content tuple. With such organization, an ICF/ICR may carry multiple Type+Content tuples of common dynamic control information, where a single Per-STA Initial Control Per AID TID Info field carries one Type+Content tuple and a single Common Initial Control Per AID TID Info field carries one single Type+Content tuple. Further, the Type+Content tuples defined in UHR/Wi-Fi 8 can be carried before Type+Content tuples defined for a next amendment to the 802.11 standard (e.g., NG-UHR, Wi-Fi9) for purposes of backwards compatibility. For example, when a UHR (or later) STA receives a Type+Content tuple that it does not recognize, the STA may stop decoding the following Type+Content tuple(s), if any, in an ICF/ICR.

In another example, when a wireless device transmits a BSRP Trigger frame that solicits dynamic initial control information from a STA, the STA needs to be allocated sufficient resources for decoding the BSRP Trigger frame and preparing a response that includes the solicited dynamic initial control information. If the BSRP Trigger frame also solicits a resource request from the STA, the allocated resources are further sufficient to include the resource request in the response. If an addressed STA does not have information to report for a solicited type of information, a response/ICR from the STA may omit the related Type+Content tuple or, alternatively, carry the related Type+Content tuple with a value in a Content field of the responding ICR that indicates no information is reported.

In a further example, when a BSRP Trigger frame solicits dynamic initial control information from a recipient wireless device, the BSRP Trigger frame may explicitly indicate the solicited type(s) of dynamic initial control information, the STA is allocated sufficient resources to prepare a TB PPDU carrying all of the solicited dynamic initial control information supported by the STA. If the BSRP Trigger frame also solicits a resource request from the STA, the allocated resources are further sufficient to include the resource request in the TB PPDU. If an addressed STA does not have information to report for a solicited type of information, a response/TB PPDU from the STA may omit the related Type+Content tuple or, alternatively, carry the related Type+Content tuple with an invalid value in a Content field of the responding TB PPDU.

In another example, when a BSRP Trigger frame solicits dynamic initial control information and/or a resource report from a peer wireless device, and responsive dynamic initial control information is carried in a non-TB PPDU, the transmit opportunity (TXOP) holder can calculate the length of the responsive PPDU based on the primary Modulation Coding Scheme (MCS) and the length of the solicited dynamic initial control information. The length of the responsive PPDU may be further based on length of a solicited resource request. If a peer device does not have information to report for a solicited type of information, a responsive PPDU may omit the associated Type+Content tuple or, alternatively, carry the related Type+Content tuple with a value in a Content field of the responding PPDU that indicates no information is reported. In a still further example, when a responding device supports at least one feature related to a received ICF or BSRP Trigger frame (e.g., a low-capability listening mode) but does not support transmission of dynamic initial control information, the responding device transmits a responsive Multi-STA BA with no BA bitmap or, alternatively, a QoS Null frame.

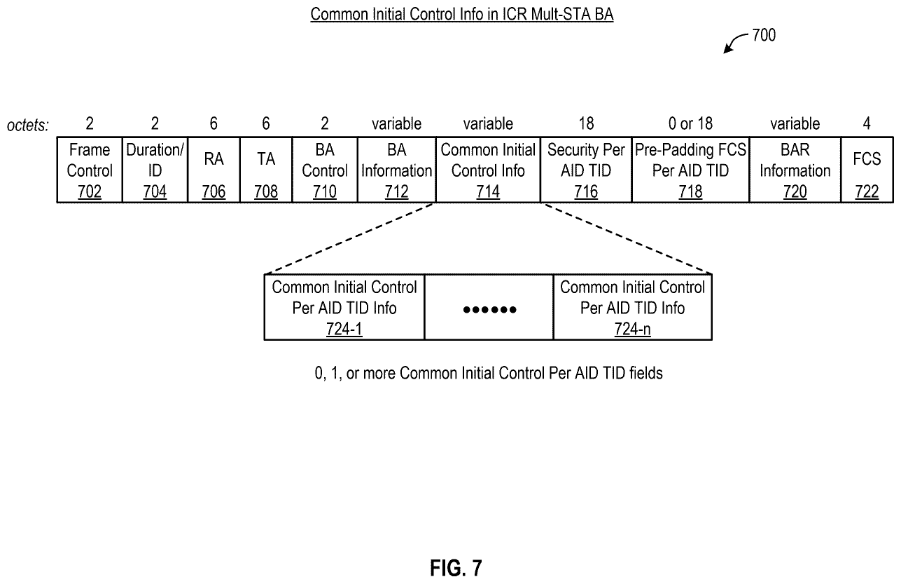

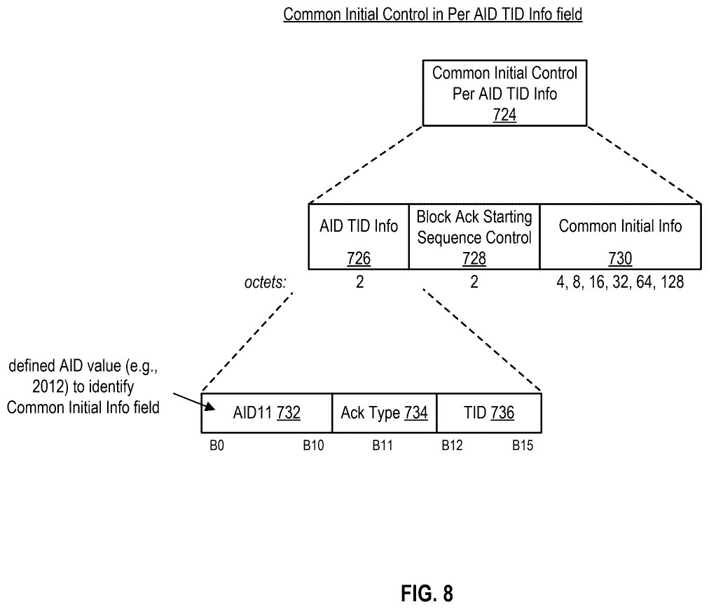

FIG. 7 illustrates an example of an Initial Control Response (ICR) Multi-STA Block Acknowledgement (BA) frame 700 including common initial control information in accordance with embodiments of the present disclosure. The Multi-STA BlockAck frame of the illustrated example includes a plurality fields, including a Frame Control field 702, a Duration/ID field 704, an RA field 706, a TA field 708, a BA Control field 710, a BA Information field 712, a Security Per AID TID field 716, a Pre-Padding FCS Per AID TID field 718, a BAR Information field 720, and an FCS field 722. The Multi-STA BA frame 700 further includes a Common Initial Control Information field 714 composed of one or more Common Initial Control Per AID TID Information fields 724-n carrying common initial control information of the ICR. An example of a Common Initial Control Per AID TID Information field 724 is described more fully with reference to FIG. 8.

In an example, a Common Initial Control Per AID TID Info field 724 is only permitted to carry a single Type+Content tuple. In another example, the combination of Common Initial Control Per AID TID Information fields 724 in a Common Initial Control Information field 714 carries all of the required/solicited common initial control information included in the (ICR) Multi-STA BA frame 700. The combination of fields may result, for example, in reduced overhead (e.g., a number of fields and/or unused bits) for communicating required common initial control information. In this example, only the last Common Initial Information field of a (last) Common Initial Control Per AID TID Information (or “Info”) field 724 may include unused bits.

FIG. 8 illustrates an example of the Common Initial Control Per AID TID Info field 724 of FIG. 7 in accordance with an embodiment of the present disclosure. The Common Initial Control Per AID TID Info field 724 of this example includes an AID TID Information field 726, a (repurposed) Block Ack Starting Sequence Control field 728, and a Common Initial Information field 730 (e.g., 4, 8, 16, 32, 64 or 128 octets) carrying common initial control information of an ICR.

The AID TID Info field 726 of this example includes an AID11 subfield 732, an Ack Type subfield 734, and a Traffic Identifier (TID) subfield 736. In an example, the AID11 subfield 732 is (re)defined to include a special value (e.g., 2012 or other defined value greater than 2007) to identify a Common Initial Information field 730. In addition, a Fragment Number subfield of the Block Ack Starting Sequence Control field 728 can be utilized to indicate the length of the Common Initial Information field 730 (e.g., using the same coding for a Fragment Number subfield indicating the length of a legacy Block Ack Bitmap field). In another example, the Ack Type subfield 734 is set to 0 and the TID subfield 736 is reserved. The lengths of the foregoing fields of the Common Initial Control Per AID TID Info field 724 are provided by way of example, and differing implementations may have subfields including a greater number of bits or a lesser number of bits.

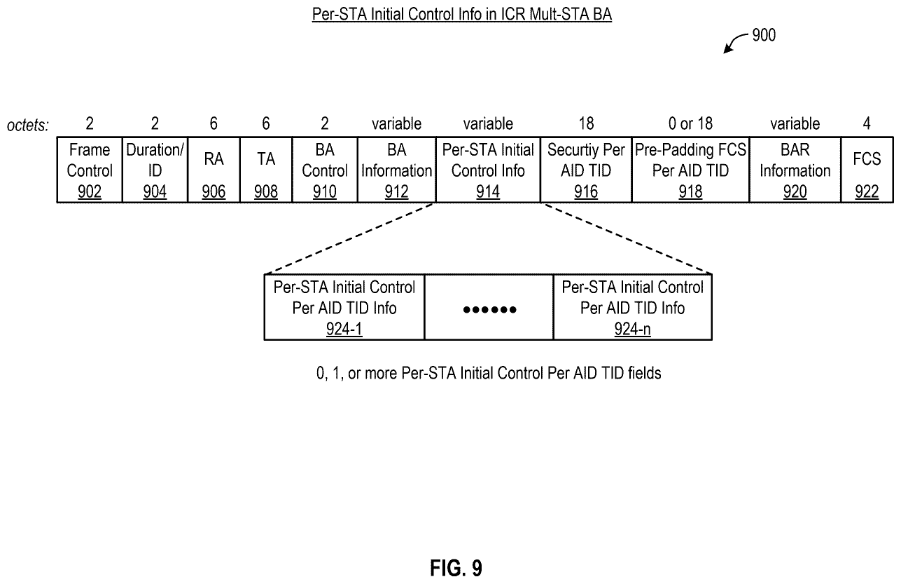

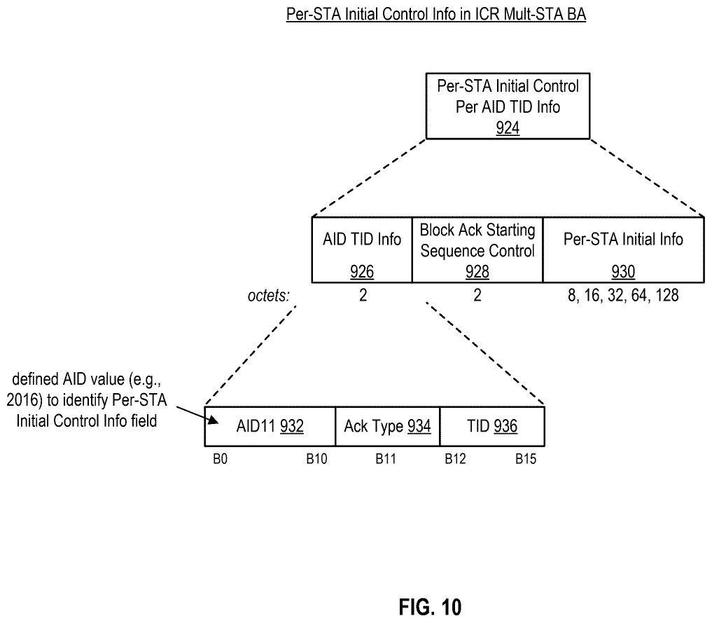

FIG. 9 illustrates an example of an Initial Control Response (ICR) Multi-STA BlockAck frame 900 including per-STA initial control information in accordance with embodiments of the present disclosure. The Multi-STA BlockAck frame of the illustrated example includes a plurality fields, including a Frame Control field 902, a Duration/ID field 904, an RA field 906, a TA field 908, a BA Control field 910, a BA Information field 912, a Security Per AID TID field 916, a Pre-Padding FCS Per AID TID field 918, a BAR Information field 920, and an FCS field 922. In this example, the various fields 902-922 of the Multi-STA BlockAck frame 900 generally correspond to the similarly labeled fields of the Multi-STA BlockAck frame 700 described with reference to FIG. 7. The Multi-STA BA frame 900 further includes a Per-STA Initial Control Information field 914 composed of one or more Per-STA Initial Control Per AID TID Information fields 924-n carrying Per-STA initial control information of the ICR. An example of a Per-STA Initial Control Per AID TID Info field 924 is described more fully with reference to FIG. 10.

In an example, a Per-STA Initial Control Per AID TID Info field 924 is only permitted to carry a single Type+Content tuple. In another example, the combination of Per-STA Initial Control Per AID TID Information fields 924 in a Per-STA Initial Control Information field 914 carries all of the required/solicited per-STA initial control information included in the (ICR) Multi-STA BA frame 900. The combination of fields may result, for example, in reduced overhead (e.g., a number of fields and/or unused bits) for communicating required Per-STA initial control information. In this example, only the last Per-STA Initial Information field 930 of a (last) Per-STA Initial Control Per AID TID Information field 924 may include unused bits.

FIG. 10 illustrates an example of the Per-STA Initial Control Per AID TID Info field 924 of FIG. 9 in accordance with an embodiment of the present disclosure. The Per-STA Initial Control Per AID TID Info field 924 of this example includes an AID TID Information field 926, a (repurposed) Block Ack Starting Sequence Control field 928, and a Per-STA Initial Information field 930 (e.g., 8, 16, 32, 64 or 128 octets) carrying Per-STA initial control information of an ICR.

The AID TID Info field 926 of this example includes an AID 11 subfield 932, an Ack Type subfield 934, and a Traffic Identifier (TID) subfield 936. In an example, the AID11 subfield 932 is (re)defined to include a special value (e.g., 2016 or other defined value greater than 2007) to identify a Per-STA Initial Information field 930. In addition, a Fragment Number subfield of the Block Ack Starting Sequence Control field 928 can be utilized to indicate the length of the Per-STA Initial Information field 930 (e.g., using the same coding for a Fragment Number subfield indicating the length of a legacy Block Ack Bitmap field with the exception B0 usage is utilized). In another example, the Ack Type subfield 934 is set to 0 and the TID subfield 936 is reserved. In further examples, a special TID value (e.g., 15) in the TID subfield 936 or a Fragment Number subfield (e.g., with B0 set to 1) in the Block Ack Starting Sequence Control field 928 can be utilized to indicate that a Per AID TID Info field is a Per-STA Initial Control Per AID TID Info field 924. The lengths of the foregoing fields of the Per-STA Initial Control Per AID TID Info field 924 are provided by way of example, and differing implementations may have subfields including a greater number of bits or a lesser number of bits.

With respect to the format of a PPDU that carries an ICR frame, if multiple STA s transmit a responding ICR frame, the responding ICR frames can be carried in a UHR TB PPDU. If a single STA is solicited to transmit a responding ICR frame, the ICF can indicate whether the responding ICR frame is carried in a TB PPDU or non-TB PPDU (e.g., one of a non-HT (duplicate) PPDU or an MU PPDU addressed to a single recipient). In addition, when an ICF is addressed to an associated AP, the responding PPDU from the AP can be a SU PPDU (e.g., one of a non-HT (duplicate) PPDU or an MU PPDU addressed to a single recipient). In another example, when an ICF is addressed to an associated STA, the responding PPDU from the STA can be a TB PPDU or a SU PPDU (e.g., one of a non-HT (duplicate) PPDU or an MU PPDU addressed to a single recipient). In an example, one field in a Common User Info field, a Special User Info field, or a Per-STA Initial Control Per AID TID Info field can provide such indications.

In another example, an ICF can carry a length requirement for a PPDU carrying an ICR (“ICR_TIME”). If a neighboring device of a transmitter of an ICF utilizes the ICF to set its basic Network Allocation Vector (NAV) timer or intra-BSS NAV timer, and the ICF requires recipient devices to transmit an ICR if an idle medium is detected, the neighboring device can decide whether to reset its basic NAV timer or intra-BSS NAV timer, respectively, if the neighboring device does not detect a PPDU from an ICF transmitter within the following (pre-defined) time period after completing reception of the PPDU carrying the ICF: (2×aSIFSTime)+(ICR_TIME)+aRxPHY StartDelay+(2×aSlotTime).

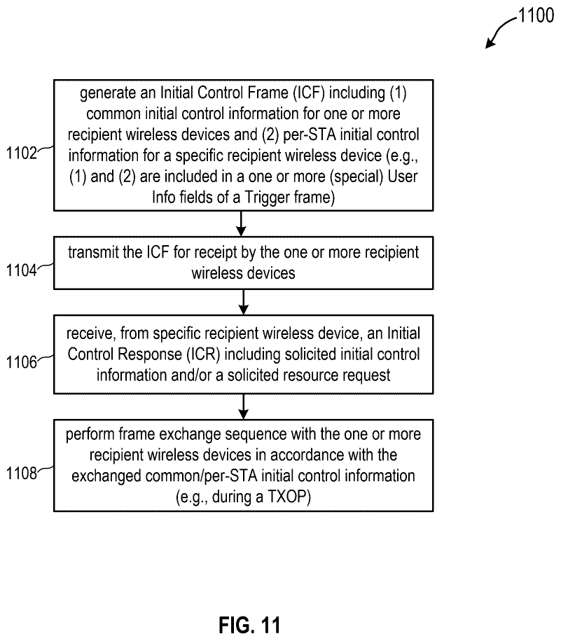

FIG. 11 is a flow chart illustrating an example method 1100 for communicating initial control information in accordance with an embodiment of the present disclosure. The method 1100 can be performed by an access point (AP) and/or station (STA), such as an AP/STA affiliated with the AP MLD 102 and the STA MLD 104 described with reference to FIG. 1, or the wireless network device/AP 1300 described with reference to FIG. 13. The method 1100 may be utilized, for example, to exchange common initial control information and per-STA initial control information. The control information may relate, for example, to at least one of in-device co-existence features or a low-capability power save mode.

The method begins at step 1102, where a first wireless device generates an Initial Control Frame (ICF) including common initial control information for one or more recipient wireless devices and per-STA initial control information for one or more specific recipient wireless devices. In an example, the ICF can be a protected/unprotected Trigger frame (e.g., a Buffer Status Report Poll (BSRP) Trigger frame) having a padding field. In this example, the common initial control information and the per-STA initial control information are carried the padding field. The padding field may further include one or more length fields indicating a length(s) of the initial control information fields. The IFC may have a format such as the formats described with reference to FIGS. 2-6.

The method continues at step 1104 where the first wireless device transmits the ICF for receipt by the one or more recipient wireless devices. The illustrated method continues at step 1106, where the first wireless device receives an Initial Control Response (ICR) from a specific recipient wireless device. The ICR may have a format such as the formats described with reference to FIGS. 7-10. The ICR can include, for example, solicited initial control information and/or a solicited resource request. The method continues at step 1108 where the first wireless device performs a frame exchange sequence(s) with the one or more recipient wireless devices in accordance with the exchanged common/per-STA initial control information (e.g., during a TXOP).

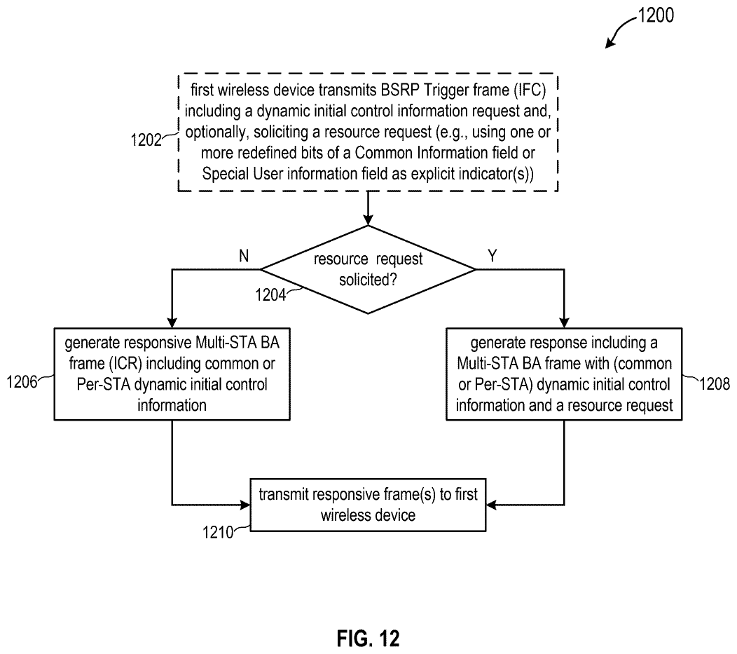

FIG. 12 is a flow chart illustrating another example method 1200 for communicating initial control information and resource requests in accordance with an embodiment of the present disclosure. The method 1200 can be performed by an access point (AP) and/or station (STA), such as an AP/STA affiliated with the AP MLD 102 and the STA MLD 104 described with reference to FIG. 1 or the wireless network device/AP 1300 described with reference to FIG. 13. The method 1200 may be utilized, for example, to exchange common/per-STA initial control information and resource requests. The control information may relate to in-device co-existence features, a low-capability power save mode, etc.

The method begins at step 1202 where a first wireless device transmits an Initial Control Frame (ICF), such as a BSRP Trigger frame, which includes a dynamic initial control information request and (optionally) solicits a resource request from a recipient wireless device. In an example, the BSRP Trigger frame includes one or more explicit indicators for a dynamic initial control information request or to solicit a resource request. In this example, the explicit indicators may be carried in one or more redefined bits of a Common Information field or a Special User information field of the BSRP Trigger frame. In another example, the dynamic initial control request and/or resource request are implicitly solicited by the BSRP Trigger frame. The IFC may have a format such as the formats described with reference to FIGS. 2-6.

The method continues at step 1204, where the recipient wireless device determines whether the IFC solicits a resource request (e.g., by decoding an explicit indicator bit(s)). If a resource request is not solicited, the method continues at step 1206 where the recipient wireless device generates a responsive Multi-STA Block Acknowledgement (BA) frame (ICR) including the solicited common/Per-STA dynamic initial control information. If a resource request is solicited by the ICF, the method continues at step 1208 where the recipient wireless device generates a responsive Multi-STA BA frame/ICR including the solicited common/Per-STA dynamic initial control information and a resource request. The Multi-STA BA frame may have a format such as the formats described with reference to FIGS. 7-10. Following either of steps 1206 or 1208, the recipient transmits the responsive ICR to the first wireless device at step 1210.

FIG. 13 illustrates an example of a wireless device that is configured as an access point (AP) 1300 according to an embodiment of the present disclosure. The AP 1300 is configurable to generate and receive frame formats according to any of the various embodiments described herein, and to exchange initial control information with one or more other wireless devices. The illustrated AP 1300 includes a host processor 1302 coupled to a network interface device 1304. The network interface device 1304 includes a medium access control (MAC) processing unit 1306 and a physical layer (PHY) processing unit 1308. The PHY processing unit 1308 includes a plurality of transceivers 1310 coupled to a plurality of antennas 1312. Although three transceivers 1310 (1310-1, 1310-2 and 1310-3) and three antennas 1312 (1312-1, 1312-2 and 1312-3) are illustrated in FIG. 1, the AP 1300 includes other suitable numbers (e.g., 1, 2, 4, 5, etc.) of transceivers 1310 and antennas 1312 in other embodiments. In an example, the MAC processing unit 1306 and the PHY processing unit 1308 are configured to operate in compliance with the IEEE 802.11bn amendment to the IEEE 802.11 standard. In an example, the network interface device 1304 includes one or more integrated circuit (IC) devices. In this example, at least some of the functionality of the MAC processing unit 1306 and at least some of the functionality of the PHY processing unit 1308 can be implemented on a single IC device. As another example, at least some of the functionality of the MAC processing unit 1306 is implemented on a first IC device, and at least some of the functionality of the PHY processing unit 1308 is implemented on a second IC device. The AP 1300 may communicate (e.g., C-TDMA related communications) with a plurality of client stations and other APs, including both legacy and non-legacy client APs and stations.

In various embodiments, the PHY processing unit 1308 of the AP 1300 is configured to generate data units conforming to a non-legacy communication protocol and having formats described herein. The transceiver(s) 1310 is/are configured to transmit the generated data units via the antenna(s) 1312. Similarly, the transceiver(s) 1310 is/are configured to receive data units via the antenna(s) 1312. The PHY processing unit 1308 of the AP 1300 is configured to process received data units conforming to the non-legacy communication protocol and having formats described herein and to determine that such data units conform to the non-legacy communication protocol.

In an embodiment, when operating in single-user mode, the AP 1300 transmits a data unit to a single client station (DL SU transmission), or receives a data unit transmitted by a single client station (UL SU transmission), without simultaneous transmission to, or by, any other client station. When operating in multi-user mode, the AP 1300 transmits a data unit that includes multiple data streams for multiple client stations (DL MU transmission), or receives data units simultaneously transmitted by multiple client stations (UL MU transmission). For example, in multi-user mode, a data unit transmitted by the AP includes multiple data streams simultaneously transmitted by the AP 1300 to respective client stations using respective spatial streams allocated for simultaneous transmission to the respective client stations and/or using respective sets of OFDM tones corresponding to respective frequency sub-channels allocated for simultaneous transmission to the respective client stations. In a further example, the AP 1300 may be configured as a multi-link device, such as the AP MLD 102 described above with reference to FIG. 1.

While the innovative aspects of the present disclosure have been generally described in the context of the 802.11bn amendment, and future generations, of the IEEE 802.11 standard, a person having ordinary skill in the art will readily recognize that teachings and concepts herein may be applied to other wireless networks and standards including, for example, Long Term Evolution (LTE) standards and Bluetooth standards.

The innovative apparatus, frame formats, and methods illustrated in the drawings and described herein enable the efficient and secure exchange of control information between wireless devices of a wireless network to achieve gains in overall network throughput and other potential advantages. In an illustrative, non-limiting embodiment, a method for communicating initial control information between devices in a wireless network is provided. The method includes generating, by a first wireless device, an Initial Control Frame (ICF) or an Initial Control Response frame (ICR). The ICF or ICR includes common initial control information for one or more recipient wireless devices. The ICF or ICR further includes per-STA initial control information for a specific recipient wireless device of the one or more recipient wireless devices. The method further includes transmitting the ICF or ICR, by the first wireless device, for receipt by the one or more recipient wireless devices.

The method of this embodiment includes optional aspects. With one optional aspect, the ICF or ICR is a Trigger frame, and the common initial control information and the per-STA initial control information are included in one or more special User Info fields of the Trigger frame that precede a padding field of the Trigger frame. In another optional aspect, the Trigger frame is a Buffer Status Report Poll (BSRP) Trigger frame carrying one or more types of initial control information for the one or more recipient wireless devices. In this optional aspect, each type of initial control information for multiple recipient wireless devices is carried in one Per User Initial Control Information field, and each type of initial control information for a single recipient wireless device is carried in one Per User Initial Control Information field. In another optional aspect, a Per User Initial Control Information field for a single recipient wireless device immediately follows a User Info field allocating a resource(s) to the single recipient wireless device for a responsive PPDU transmission. In yet another optional aspect, a Per User Initial Control Information field for a single recipient wireless device includes an Association ID (AID 12) subfield having a value that identifies the single recipient wireless device.

In another optional aspect, a Per User Initial Control Information field for multiple recipient wireless devices includes an Association ID (AID 12) subfield having a value greater than 2007 and less than 2047. In yet another optional aspect, each type of initial control information is organized as Type+Content, where a Type field indicates a type of the initial control information carried in a corresponding Content field. In a further optional aspect, the first wireless device generates a Trigger frame as an ICF, and the Trigger frame includes an explicit indicator that indicates whether a responding frame is to be carried in a TB PPDU or non-TB PPDU. In another optional aspect, the explicit indicator is carried in a Common Info field of the Trigger frame.

In another optional aspect, the first wireless device generates a Multi-STA Block Ack (BA) frame as an ICR, and the common initial control information is included in one or more Common Initial Control Per AID TID Info fields of the Multi-STA BA. In a further optional aspect, each type of common initial control information is organized as Type+Content, where a Type field indicates a type of the common initial control information carried in a corresponding Content field. In yet another optional aspect, each type of common initial control information is carried in one Common Initial Control Per AID TID Info field. In another optional aspect, the Common Initial Control Per AID TID Info field includes an Association ID (AID11) subfield having a value greater than 2007. In yet another optional aspect, an ICR Multi-STA BA frame is aggregated with a QoS Null frame.

In another optional aspect, the first wireless device sets a Network Allocation Vector (NAV) timer and generates an ICR in response to receiving a PPDU including an ICF, and resets the NAV timer if the first wireless device does not detect another PPDU from a transmitter of the ICF within a pre-defined time period after completing reception of the PPDU including the ICF. In a further optional aspect, the pre-defined time period is equal to (2×aSIFSTime)+(ICR_TIME)+aRxPHY StartDelay+(2×aSlotTime).

With another illustrative, non-limiting embodiment, a wireless device includes one or more wireless transceivers and one or more processors operably coupled to the one or more wireless transceivers. The one or more processors are arranged to generate an Initial Control Frame (ICF) or an Initial Control Response frame (ICR). In this embodiment, the ICF or ICR includes common initial control information for one or more recipient wireless devices and per-STA initial control information for a specific recipient wireless device of the one or more recipient wireless devices. The one or more processors of the wireless device are further arranged to transmit, via the one or more wireless transceivers, the ICF or ICR for reception by the one or more recipient wireless devices.

This second embodiment includes optional aspects. With one optional aspect, the ICF or ICR is a Trigger frame, and the common initial control information and the per-STA initial control information are included in one or more special User Info fields of the Trigger frame that precede a padding field of the Trigger frame. In another optional aspect, the wireless device generates a Multi-STA Block Ack (BA) frame as an ICR, and the common initial control information is included in one or more Common Initial Control Per AID TID Info fields.

In another illustrative, non-limiting embodiment, a method for communicating initial control information by a first wireless device is provided. The method includes receiving an Initial Control frame (ICF) from a second wireless device. The ICF solicits dynamic initial control information from the first wireless device. In response to receiving the ICF, the method further includes generating a Multi-STA Block Acknowledgement (BA) frame for receipt by the second wireless device. The Multi-STA BA frame includes at least one of a Common Initial Control Information field including common initial control information in one or more Common Initial Control Per AID TID Info fields, or a per-STA Initial Control field including per-STA initial control information, for the second wireless device, in one or more Per-STA Initial Control Per AID TID Info fields having an Association ID subfield identifying the second wireless device.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for communicating initial control information between devices in a wireless network, the method comprising:
generating, by a first wireless device, an Initial Control Frame (ICF) or an Initial Control Response frame (ICR) including:
common initial control information for one or more recipient wireless devices; and
per-STA initial control information for a specific recipient wireless device of the one or more recipient wireless devices; and
transmitting, by the first wireless device, the ICF or ICR for receipt by the one or more recipient wireless devices.

2. The method of claim 1, wherein the ICF or ICR is a Trigger frame, and wherein the common initial control information and the per-STA initial control information are included in one or more special User Info fields of the Trigger frame, the one or more special User Info fields preceding a padding field of the Trigger frame.

3. The method of claim 2, wherein the Trigger frame is a Buffer Status Report Poll (BSRP) Trigger frame carrying one or more types of initial control information for the one or more recipient wireless devices, and wherein each type of initial control information for multiple recipient wireless devices is carried in one Per User Initial Control Information field, and each type of initial control information for a single recipient wireless device is carried in one Per User Initial Control Information field.

4. The method of claim 3, wherein a Per User Initial Control Information field for a single recipient wireless device immediately follows a User Info field allocating a resource(s) to the single recipient wireless device for a responsive PPDU transmission.

5. The method of claim 3, wherein a Per User Initial Control Information field for a single recipient wireless device includes an Association ID (AID12) subfield having a value that identifies the single recipient wireless device.

6. The method of claim 3, wherein a Per User Initial Control Information field for multiple recipient wireless devices includes an Association ID (AID12) subfield having a value greater than 2007 and less than 2047.

7. The method of claim 3, wherein each type of initial control information is organized as Type+Content, and wherein a Type field indicates a type of the initial control information carried in a corresponding Content field.

8. The method of claim 2, wherein the first wireless device generates the Trigger frame as an ICF, the Trigger frame including an explicit indicator that indicates whether a responding frame is to be carried in a TB PPDU or non-TB PPDU.

9. The method of claim 8, wherein the explicit indicator is carried in a Common Info field of the Trigger frame.

10. The method of claim 1, wherein the first wireless device generates a Multi-STA Block Ack (BA) frame as an ICR, and wherein the common initial control information is included in one or more Common Initial Control Per AID TID Info fields.

11. The method of claim 10, wherein each type of common initial control information is organized as Type+Content, and wherein a Type field indicates a type of the common initial control information carried in a corresponding Content field.

12. The method of claim 10, wherein each type of common initial control information is carried in one Common Initial Control Per AID TID Info field.

13. The method of claim 12, wherein the Common Initial Control Per AID TID Info field includes an Association ID (AID11) subfield having a value greater than 2007.

14. The method of claim 10, wherein the Multi-STA BA frame is aggregated with a QoS Null frame.

15. The method of claim 10, wherein the first wireless device sets a Network Allocation Vector (NAV) timer and generates the ICR in response to receiving a PPDU including an ICF, and wherein the first wireless device resets the NAV timer if the first wireless device does not detect another PPDU from a transmitter of the ICF within a pre-defined time period after completing reception of the PPDU including the ICF.

16. The method of claim 15, wherein the pre-defined time period is equal to (2×aSIFSTime)+(ICR_TIME)+aRxPHY StartDelay+(2×aSlotTime).

17. A wireless device, comprising:
one or more wireless transceivers; and
one or more processors operably coupled to the one or more wireless transceivers, wherein the one or more processors are arranged to:
generate an Initial Control Frame (ICF) or an Initial Control Response frame (ICR), the ICF or ICR including:
common initial control information for one or more recipient wireless devices; and
per-STA initial control information for a specific recipient wireless device of the one or more recipient wireless devices; and
transmit, via the one or more wireless transceivers, the ICF or ICR for reception by the one or more recipient wireless devices.

18. The wireless device of claim 17, wherein the ICF or ICR is a Trigger frame, and wherein the common initial control information and the per-STA initial control information are included in one or more special User Info fields of the Trigger frame, the one or more special User Info fields preceding a padding field of the Trigger frame.

19. The wireless device of claim 17, wherein the wireless device generates a Multi-STA Block Ack (BA) frame as an ICR, and wherein the common initial control information is included in one or more Common Initial Control Per AID TID Info fields.

20. A method for communicating initial control information by a first wireless device, the method comprising:
receiving an Initial Control frame (ICF) from a second wireless device, wherein the ICF solicits dynamic initial control information from the first wireless device;
in response to receiving the ICF, generating a Multi-STA Block Acknowledgement (BA) frame for receipt by the second wireless device, wherein the Multi-STA BA frame includes at least one of:
a Common Initial Control Information field including common initial control information in one or more Common Initial Control Per AID TID Info fields; or
a per-STA Initial Control field including per-STA initial control information, for the second wireless device, in one or more Per-STA Initial Control Per AID TID Info fields having an Association ID subfield identifying the second wireless device.
